(19) United States
(12) Patent Application Publication
(10) Pub. No.: US 2008/0217443 A1
(43) Pub. Date: Sep. 11, 2008

(54) Portable pump house

(76) Inventors: Louis G. Zacherl, Broomfield, CO (US); Frederick R. Zacherl, Westminster, CO (US)

Correspondence Address: RYAN KROMHOLZ & MANION, S.C., POST OFFICE BOX 26618, MILWAUKEE, WI, 53226, US

(21) Appl. No.: 12/074,325

(22) Filed: Mar. 3, 2008

Related U.S. Application Data
(60) Provisional application No. 60/904,579, filed on Mar. 2, 2007.
(60) Provisional application No. 60/964,182, filed on Aug. 9, 2007.

(51) Int. Cl. B05B 3/00; A62C 25/00; A62C 3/00

(52) U.S. Cl. 239/722; 169/52; 169/43

(57) ABSTRACT

An automated or manually operated portable pump house for producing water pressure includes a portable housing structure, a fire pump positioned within the housing structure, a fire pump driver operably coupled to the fire pump, means for controlling the fire pump driver operably coupled to the fire pump driver, a pressure control pump positioned within the housing structure, means for controlling the pressure control pump operably coupled to the pressure control pump, means for electrical power generation positioned within the housing structure, and means for automatically detecting and reporting a status condition to an external location.

### RELATED APPLICATIONS

This application claims the benefit of U.S. Provisional Patent Application Ser. No. 60/904,579, filed 2 Mar. 2007, and entitled “Portable Pump House,” and U.S. Provisional Patent Application Ser. No. 60/964,182, filed 9 Aug. 2007, and entitled “Portable Pump House,” which are incorporated herein by reference.

### FIELD OF THE INVENTION

This invention relates generally to fluid pumping systems, and more specifically to portable pumping systems adapted for use with systems requiring water pressure.

### BACKGROUND OF THE INVENTION

A system requiring water pressure such as a fire sprinkler system, as a non-limiting example, provides a discharge of fluid, i.e., water, when the effects of a fire have been detected or a fire hose has been opened. A fire pump system is typically permanently installed within a building and is connected to the fire sprinkler system to produce water pressure when the water pressure in the sprinkler system falls below a threshold. The sprinkler system pressure drops significantly when one or more fire sprinklers open. A fire sprinkler typically opens due to exposure to heat above their design temperature, which releases the water.

Fire pumps are typically powered by a power source. When electric power is available, an electric motor or drive may be used. In applications where electric power may not be available, a combustion engine may be used, such as a diesel or gasoline powered engine. If the local building code requires power independent of the local electric power grid, a fire pump using an electric motor may utilize an emergency generator when connected via a listed transfer switch.

Fire pumps are generally needed when the local municipal water system cannot provide sufficient pressure to meet the hydraulic design requirements of the fire sprinkler system. Fire pumps are also generally needed if the fire protection water supply is provided from a ground level water storage tank.

Because fire pump systems often protect property of considerable personal and monetary value, the fire pump systems are periodically performance-tested to ensure their operability when needed. A test is first performed on a fire pump system when it is installed in a facility. The fire pump system is then performance-tested typically on an annual basis and started and run weekly to make sure that it continues to operate properly.

When the installed fire pump is taken off-line, a “temporary” fire pump system must be connected to the fire sprinkler system to ensure uninterrupted operability of the sprinkler system. The temporary fire pump typically consists of a fire engine from the local fire department. The use of the fire engine requires constant oversight by at least one or more of the firemen trained to operate the fire engine. This requirement to have the fire engine manned comes at an expense. In addition, use of the fire engine as the temporary fire pump is not well suited for extended periods of use if the installed fire pump is off-line for more than a few hours.

There remains a need for a truly portable fire pump system that can be conveniently transported from site to site and can remain on site for as long as necessary and that can be configured to operate with or without an on-site operator.

### SUMMARY OF THE INVENTION

An improved fire pump house provides systems and methods for producing water pressure to a system adapted to receive water pressure, such as a fire suppression sprinkler system.

One aspect of the invention provides a portable pump house. The portable pump house may comprise a variety of elements, including a portable housing structure, a fire pump positioned within the housing structure, the fire pump including a fire pump inlet and a fire pump discharge. A fire pump driver is operably coupled to the fire pump, with means for controlling the fire pump driver positioned within the housing structure. A pressure control pump is configured in parallel fluid flow communication with the fire pump, the pressure control pump positioned within the housing structure, and the pressure control pump including a pressure control pump inlet and a pressure control pump discharge, with means for controlling the pressure control pump positioned within the housing structure.

The portable pump house may also comprise means for electrical power generation positioned within the housing structure, and means for automatically detecting and reporting a status condition to an external location.

Another aspect of the invention provides a portable system for producing water pressure. The portable system may comprise a variety of elements including a fire pump coupled to a fire pump mounting base, the fire pump including a fire pump inlet and a fire pump discharge, a fire pump driver operably coupled to the fire pump, and means for controlling the fire pump driver operably coupled to the fire pump driver. A pressure control pump is configured in parallel fluid flow communication with the fire pump, the pressure control pump coupled to a pressure control pump mounting base, and the pressure control pump including a pressure control pump inlet and a pressure control pump discharge, with means for controlling the pressure control pump operably coupled to the pressure control pump.

The portable pump house may also comprise water inlet piping in fluid communication with the fire pump inlet and the pressure control pump inlet, and water discharge piping in fluid communication with the fire pump discharge and the pressure control pump discharge. Means for electrical power generation may be positioned within the housing structure, and means for automatically detecting and reporting a status condition to a remote location may also be positioned with the housing structure.

Yet another aspect of the invention comprises a method of producing water pressure using a portable pump house. The method may include a variety of steps, including transporting the portable pump house as described herein to a predetermined job site, coupling the portable pump house to a water supply, coupling the portable pump house to a system adapted for receiving water pressure, and operating the portable pump house to produce water pressure.

After use, the water supply is disconnected from the portable pump house and the portable pump house is transported to another job site, or to storage.

Other features and advantages of the inventions are set forth in the following specification and attached drawings.

### BRIEF DESCRIPTION OF THE DRAWINGS

FIG. 1 is a schematic view of one embodiment of a portable pump house configuration.

FIG. 1A is a close-up detailed view of a section of line used as part of the portable pump house of FIG. 1.

FIG. 2 is a side view of one embodiment of a portable pump house configuration, the portable pump house including wheels for transportation.

FIG. 3 is a side view of an alternative embodiment of a portable pump house configuration, the portable pump house being transported on or in a truck.

FIG. 4 is a side view of one embodiment of a mounting base usable with the portable pump house configuration, to allow for alignment of system components.

FIG. 5 is a schematic view of an alternative embodiment of the portable pump house configuration shown in FIG. 1

### DESCRIPTION OF THE PREFERRED EMBODIMENTS

Although the disclosure hereof is detailed and exact to enable those skilled in the art to practice the embodiments, the physical embodiments herein disclosed merely exemplify the invention which may be embodied in other specific structures. While the preferred embodiments have been described in relation to a portable (i.e., transportable) fire suppression sprinkler pumping system, the details may be changed without departing from the invention, which is defined by the claims.

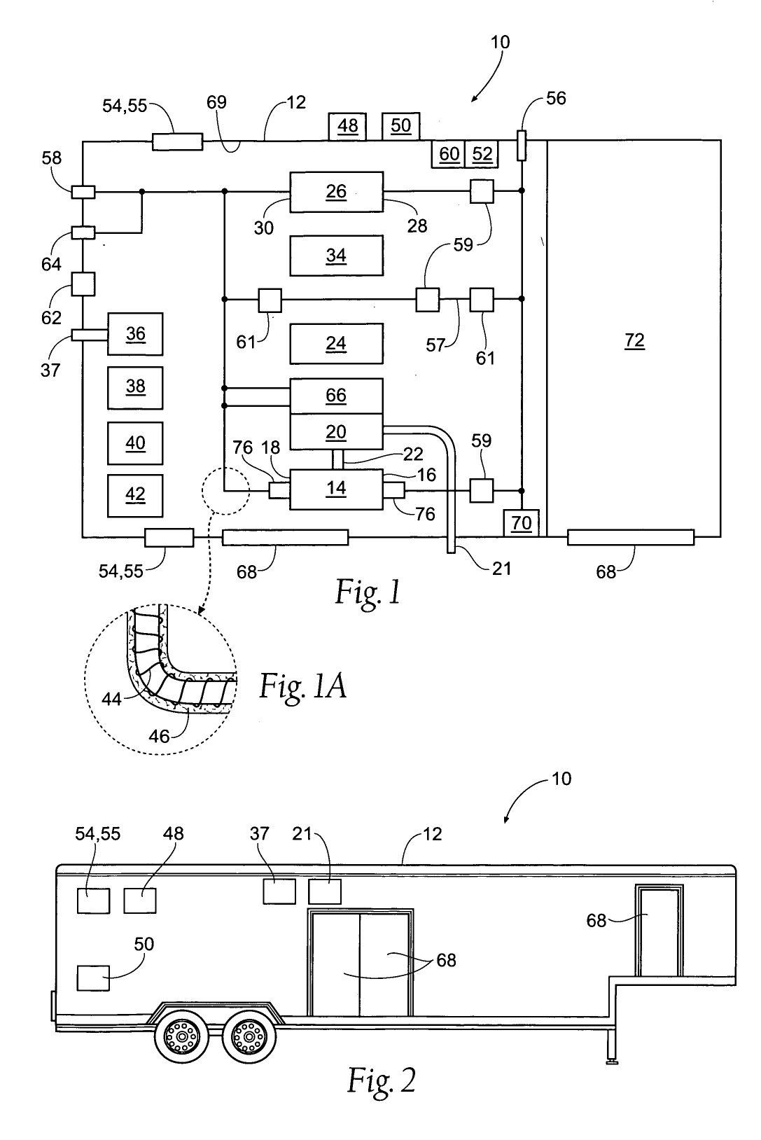

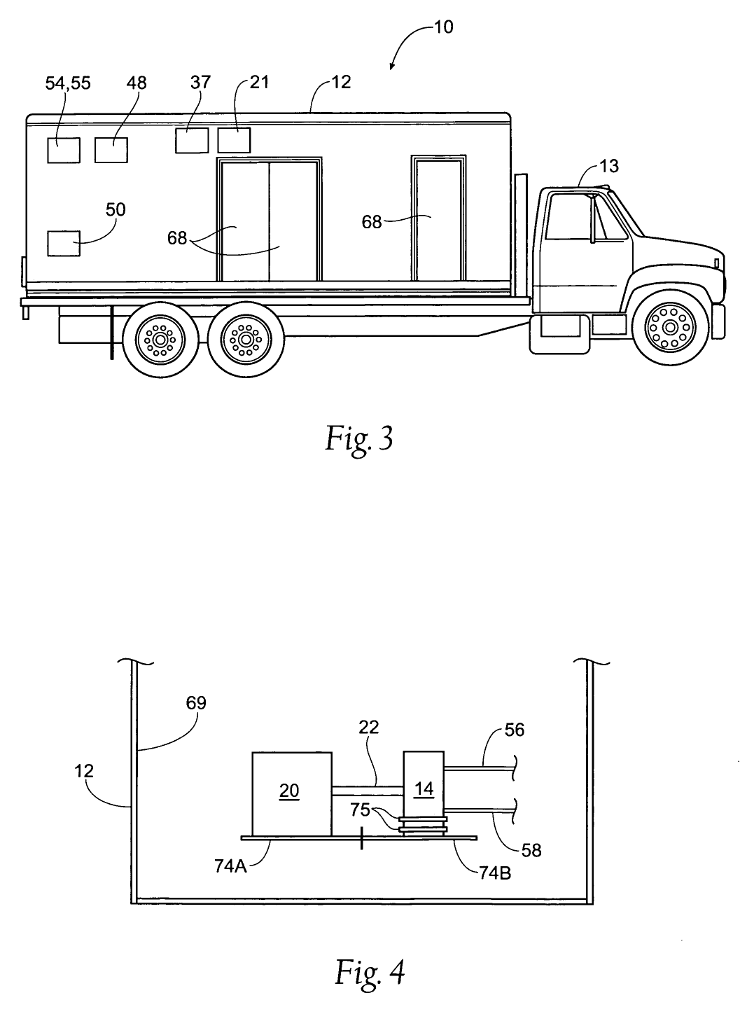

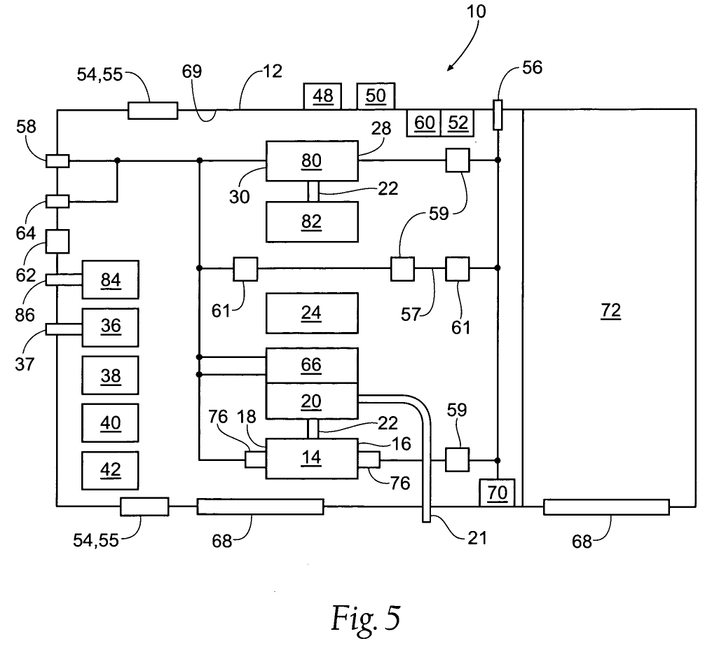

As can be seen in FIG. 1, the portable pump house 10 is a complete, self-contained, automated, fire suppression sprinkler pumping system that may be housed in any suitable transportable structure or housing 12. Examples of such structures include wheeled, “over the road” type vehicles, such as trailers 12 (see FIG. 2). Alternatively, shipping-type containers, transportable skid-mounted buildings, or other housings 12 carried on an over the road vehicle may be used (see FIG. 3). It is to be understood that the exact housing structure for the portable pump house may be varied according to the specific requirements of the work site. A portable pump house 10 is preferably constructed to the intent of the National Fire Protection Assoc. (NFPA) pamphlet 20 standard, and uses Underwriters Laboratory listed, labeled components that conform to Factory Mutual requirements.

Again referring to FIG. 1, components which may be included as elements of the portable pump house 10 may include, by way of non-limiting example:

1) A fire protection pump 14, such as the Peerless 3000 GPM, 110 PSI pump; the fire protection pump 14 including an inlet 16 and a discharge 18.

2) A fire pump driver 20, such as a Detroit Allison 350 HP 2300 RPM diesel engine and associated muffler 21; the fire pump driver 20 being coupled to the fire protection pump 14 by way of a coupling 22 known in the art.

3) A fire pump controller 24, such as the Metron FD-2, for automating the control of the fire pump driver 20 and fire pump 14.

4) A pressure pump 26, such as a regenerative turbine; the pressure pump 26 including an inlet 28 and a discharge 30.

5) A pressure pump controller 34, such as the Metron model M-15B for automating the control of the pressure pump 26.

6) A generator 36, such as a 208 VAC, three-phase diesel driven generator and associated muffler 37, for providing power to the portable pump house system 10.

7) A transformer 38, such as the Westinghouse 460-230 VAC input/208 VAC output 25 KVA 3 phase transformer, used in a power distribution system 52.

8) A system for detecting and/or reporting status conditions 40, such as an alarm system and/or cellular telephone auto dialer and/or supervisory control and data acquisition (SCADA) system.

9) A Low Suction Panel 42, such as the Metron model MLS1815, for identifying low inlet pressure.

Additionally, it is understood that all elements of the portable pump house 10, including any necessary space heaters, vents, louvers, cooling means, fuel tanks, mufflers, batteries, antennas, backflow preventers, check valves, external indicators, etc. are supplied in accordance with the above standards, and may be positioned within the housing 12, external the housing 12, or a combination of both internal and external (e.g., vents, louvers, mufflers, as non-limiting examples).

Water may be supplied to the portable pump house 10 from either a storage tank or municipal mains (not shown) by way of multiple parallel lines having predetermined diameters as needed. As a non-limiting example, one four-inch, and one six-inch or, three 4-inch parallel lines may be used. Discharge of water may be into either the facility's fire department connection or the facility's existing test header. The portable pump house system 10 is devised such that multiple lines may be connected at one time, for example, ten 2½-inch lines may be connected simultaneously, if desired. Preferably, all lines may be heat traced 44 and insulated 46 for freeze protection, as required, to allow operation in below freezing temperatures without the need to maintain a flow of water through the system to prevent freeze-up.

In the event of overloading or loss of the water supply, the portable pump house 10 includes means to 1) issue a low suction or inlet pressure alarm, and/or 2) if the situation persists long enough, cause fire pump driver 20 shutdown. Means may be in the form of the low suction panel 42, such as the previously mentioned Metron low suction panel, for example.

The pressure pump 26 keeps the discharge lines pressurized at all times. The pressure pump 26 is also known in the art as a jockey pump, and is configured to provide fluid flow in parallel with fluid flow through the fire pump 14.

The pressure pump 26 is a small pump typically connected to a fire sprinkler system in parallel with the fire pump. It maintains pressure in a fire protection piping system to an artificially high level so that the operation of a single fire sprinkler will cause an appreciable pressure drop which will be easily sensed by the fire pump automatic controller, causing the fire pump to start. The jockey pump is essentially a portion of a fire pump's control system.

Several status points, which may include alarm points, may be monitored by the portable pump house system 10. For example status points which may be monitored by the portable pump house system include:

1) Fire pump in automatic mode

2) Fire pump batteries okay

3) Fire pump driver (i.e., engine) running

4) Engine low oil pressure*

5) Engine low/high coolant temperature*

6) Fire pump controller loss of AC power*

7) Engine overspeed shutdown*

8) Engine failed to start*

9) Low fire pump engine fuel level*

10) Low/high pump room temperature

11) Low suction (inlet) pressure

12) Low generator fuel level

13) AC power phase loss or phase rotation

14) Heat trace ground fault

Certain alarm/status points (i.e., conditions) may be monitored by the fire pump driver controller 24. Points that may be monitored as a part of a system failure alarm from the fire pump driver controller 24 may include those identified above by an asterisk.

Preferably, the portable pump house system 10 includes means 40 for detecting and/or reporting status conditions to an external location. The system 10 may be adapted to automatically or manually feed the alarm/status points to an auto-dialer, or other means, for automatic transmission to a remote monitoring location, such as a continuously attended monitoring station. As such, the portable pump house may be completely operable without the need for a constant attendant to operate the system 10. The monitoring station will then contact the responding parties. Additionally, the portable pump house system 10 may further include external horns and/or strobes 48 to be activated by the alarm/status points to thereby alert on-site personnel of system status or trouble.

The power requirements of the portable pump house 10 may be met in a variety of ways. For example, the portable pump house may 1) include its own on-board generator 36, such as a three phase diesel driven generator (i.e., gen-set) or 2) a temporary power supply may be connected, such as 208/230/460 VAC power.

If the portable pump house 10 system is supplied with an on-board power generator 36, such as the mentioned example, it may be driven by a four-cylinder 120 cubic inch diesel engine to thereby produce up to 25 KVA of 208 VAC three-phase power, as a non-limiting example. It is contemplated that a power generator 36 such as this is sufficient for fire pump driver preheating, battery charging, freeze protection, internal lighting, and pressure pump requirements. When supplied with an on-board power generator 36, a muffler 37 may be used to quiet the power generator 36 when the portable pump house 10 is used in noise sensitive areas since the power generator 36 is capable of running continually.

Alternatively, temporary local electrical power may be used to directly supply to the portable pump house 10 at an external lockable fused disconnect switch 50, for example. The portable pump house 10 preferably includes a complete internal power distribution system 52. When supplied from a local source, the portable pump house 10 is silent until either an alarm occurs or the fire pump driver 20 starts. Typical demand on the local power supply does not exceed 25 KVA, although the demand may vary according to the specific requirements of the job site.

The portable pump house 10 further preferably includes means 54 for internal temperature control. For example, when used in a cool or cold surrounding environment, it may be required to maintain the portable pump house's internal system temperature at a point greater than the surrounding environment. This may be achieved by way of an internal air space heater or water heater, by way of examples. When the portable pump house is used in warm or hot environments, the internal system temperatures may raise unacceptably.

The portable pump house system may also be provided with means 55 for internal cooling. For example, should the internal temperature of the system exceed a predetermined temperature, such as above 85 degrees F., ventilation louvers and/or an exhaust fan and/or air conditioning system will attempt to cool the portable pump house internally to local ambient temperature. The ventilation louvers may also be adapted to open during driver runs to supply combustion air.

Both the fire pump driver 20 high temperature limits and the low temperature limits may be monitored. For example, two temperature switches may be provided. The high temperature switch may be adapted to indicate a loss of cooling, while the low limit switch may be adapted to detect an engine block heater failure.

All water connections (i.e., lines) may be made with piping, although the water connections to be made through hoses. The portable pump house 10 may include water inlet lines 56 in fluid communication with the fire pump inlet 16 and the pressure control pump inlet 28. The portable pump house 10 may also include water discharge lines 58 in fluid communication with the fire pump discharge 18 and the pressure control pump discharge 30, and optionally, a main relief valve 64. Check valves 59 may be placed throughout the inlet lines 56 and discharge lines 58 as needed.

A bypass connection 57, allows the water inlet lines 56 to be in direct fluid flow communication with the water discharge lines 58, for example, if the fire pump 14 fails, so at a minimum, water can be provided from the inlet lines to the discharge lines. The bypass connection may also include isolation valves 61 as needed.

Further, for freeze protection, all lines preferably include means 44 for heat tracing installed and may be wrapped with insulation 46, such as closed cell foam sleeves. Waterproof electrical connections are made between the hose sections when several sections must be connected in series. Means 60 for ground fault protection and associated alarms are preferably provided on at least the heat trace circuits.

The portable pump house system 10 further includes means 62 for water discharge. Provisions such as a drain may be included for water to discharge from inside of the housing structure 12 to the outside of the housing structure 12. The water from inside the housing structure 12 may come from a plurality of sources including by way of non-limiting example:

1) fire pump packings,

2) fire pump driver cooling and

3) a main relief valve 64.

The above mentioned means 62 may be accomplished similarly to that of stationary pumper installations. Discharge may be accomplished through the bottom of the housing structure 12 to the ground.

By way of background, fire pumps are not typically supplied with seals, but rather with packings. By their nature, packings require a slow steady drip of water at all times. This water drip lubricates the packing to pump shaft interface as it rotates. At setup these packings are adjusted to provide the correct, predetermined flow of, for example, one drop per second from both sides of the pump. A slow flow such as this is most troublesome during freezing weather.

While the fire pump driver 20 is running, it may be cooled by diverting a flow (e.g., approximately two percent) of the pump's design flow from the pump discharge 18 to a liquid-to-liquid heat exchanger 66 on the fire pump driver 20. This water may be heated, by the exchanger, to approximately 100 degrees F. prior to discharge. The flow rate is more than adequate to prevent fire pump damage when operating at no-flow conditions. Flowing an amount of water through the pump when it is being driven prevents the water from overheating. The fire pump driver's cooling requirement is typically several times that of the fire pump, and the fire pump typically gets cooled first.

To prevent over-pressurization of the discharge of the pump in cases of high inlet pressure, the portable pump house 10 may be equipped with a main relief valve 64. This valve 64 is sized to flow the full capacity of the fire pump 14 if necessary. The flow is limited to that necessary to reduce discharge pressure to the working pressure of the sprinkler system components, usually 175 PSI, for example, in the event of an engine overspeed or “run-away”.

As mentioned previously, the portable pump house system 10 may also be further provided with portable housing 12, and may be housed in any suitable portable structure. Examples of such structures include wheeled, “over the road” type vehicles, such as trailers 12 (see FIG. 2), but also may include shipping-type containers, transportable skid-mounted buildings, or other housings 12 that are carried on a wheeled, over the road vehicle (see FIG. 3). It is to be understood that the exact housing structure for the portable pump house 10 may be varied according to the specific requirements of the work site. Further, the portable housing structure 12 may include a “walled off” section 72 to provide an additional space, such as office space, parts storage, sleeping quarters, or any combination.

If the pump house system is to be housed in an “over the road” trailer, a suitable “over the road” trailer may be derived from a standard “deep drop moving van” as a non-limiting example. This configuration is convenient since it allows the fire pump driver 20 and fire pump 14 to be located in the “drop.” As non-limiting examples, the inlet 56 and discharge 58 piping may be placed on ahead and behind the fire pump 14 for pumps installed with the driveshaft arranged “transverse” or across the housing 12, and the inlet 56 and discharge 58 piping may be stacked atop one another when the driveshaft is aligned along the length or “longitudinal” of the housing 12.

Means 68 for interior access may include side doors, including double wide side doors, which may also be located in the drop, to allow not only interior access but also a means to swap equipment, such as a fire pump 14, for other equipment, as required. The interior of the trailer 12 may be completely lined with “Duro-Rock” concrete sheeting 69, or the like, such as interconnected metal open sided boxes which have been filled with insulation and covered with perforated metal panels thereby providing side and top structure, and thermal and acoustic benefits. The trailer 12 may be further equipped with its own internal sprinkler system 70 fed from the incoming water supply 56.

If the portable pump house system is housed in a transportable container (i.e., housing 12), a secondary transport vehicle 13 may be required to move the system to the job site (see FIG. 3). A transportable container 12, such as those mentioned above by way of non-limiting example, may also be lined with “Duro-Rock” concrete sheeting, or the like, such as interconnected metal open sided boxes which have been filled with insulation and covered with perforated metal panels thereby providing side and top structure, and thermal and acoustic benefits. The transportable container 12 may be further equipped with its own internal sprinkler system 70 fed from the incoming water supply 56, in the same manner as the trailer-type housing.

In use, the fire pump driver 20 may allow operation at speeds below 2100 RPM. It is possible to operate, for example, a 3000 GPM, 125 PSI, 2100 RPM pump at 1850 RPM and achieve a 2500 GPM, 90 PSI pump. Of course, the fire pump driver 20 must be able to produce enough torque to drive the fire pump 14 at the lower output. The fire pump driver 20 may operate at less than full speed if a set-point maximum pressure has been reached. This feature may be a component of the fire pump controller system 24, and may be activated through software.

For those applications that require a different output than can be achieved by slowing a larger fire pump, the portable pump house 10 may include features to allow quick change out of one fire pump 14 and/or fire pump driver 20 for another. As can be seen in FIG. 4, mounting base structure 74A and 74B allows the fire pump 14 to be installed using pre-cut spacers 75. Prefabricated spacers 75 as necessary are used to align the fire pump 14 with the inlet 56 and/or discharge lines 58.

The design of the lines preferably uses eccentric reducers 76 on both sides of the pump. When installed in centrifugal pump piping, eccentric reducers 76 help to reduce trapped air, which can destroy pumping action if it gets into the pump.

An alternative type of fire pumping system is sometimes referred to as a combined use system. In a combined use system, the flow of water is not necessarily an indication of an emergency condition. Combined use systems are used in facilities such as prisons and college campuses, as non-limiting examples. A common set of pipes are used to provide water for two or more purposes, such as turf irrigation water being combined with a fire protection use, such as street hydrants or sprinkler heads.

In such a combined use system, the constant speed pressure pump 26 may be replaced with a larger pressure pump 80 driven by a pressure pump driver 82, such as a variable frequency drive. The pressure pump 80 may be coupled to the pressure pump driver 82 by way of a coupling 22 known in the art. This larger pressure pump (i.e., jockey pump) and variable frequency drive may be used to maintain constant discharge pressure for the non-emergency flow (e.g., turf irrigation). In the event that a large demand is placed on the system and the pressure falls too far for to long then the fire pump 14 would come on line.

The pressure pump driver 82 may be powered using the generator 36, an additional generator 84, with exhaust 86, or the job-site may supply the portable pump house system 10 with a high-power electrical supply.

The portable pump house system 10 is used for producing water pressure. Methods for using the portable pump house may include a variety of steps. For example, the portable pump house is transported to a location in need of a system for producing water pressure. The inlet lines 56 may then be coupled to a water supply, and the discharge lines may then be coupled to a system adapted for receiving water pressure. The portable pump house is then configured for automatic or manual operation, and will come on-line when a drop in water pressure is detected.

After use, which may include days, weeks, or months, the water supply is disconnected from the portable pump house and the portable pump house is transported to another job site, or to storage.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention, which is defined by the claims.

We claim:

1. A portable pump house comprising:
a portable housing structure,
a fire pump positioned within the housing structure, the fire pump including a fire pump inlet and a fire pump discharge,
a fire pump driver operably coupled to the fire pump,
means for controlling the fire pump driver positioned within the housing structure,
a pressure control pump in parallel fluid flow communication with the fire pump, the pressure control pump positioned within the housing structure, the pressure control pump including a pressure control pump inlet and a pressure control pump discharge,
means for controlling the pressure control pump positioned within the housing structure,
means for electrical power generation positioned within the housing structure, and
means for automatically detecting and reporting a status condition to an external location.

2. The portable pump house according to claim 1:
wherein the pressure control pump comprises a constant speed jockey pump.

3. The portable pump house according to claim 1:
wherein the pressure control pump comprises a variable speed jockey pump.

4. The portable pump house according to claim 3:
wherein the means for controlling the pressure control pump comprises a variable speed drive.

5. The portable pump house according to claim 1 further including:
a plurality of wheels operably coupled to the housing structure, the plurality of wheels adapted to allow the portable pump house to be transported over the ground.

6. The portable pump house according to claim 1:
wherein the portable pump house is operable independent of an external electrical power source.

7. The portable pump house according to claim 1:
wherein the means for detecting and reporting a status condition to an external location reports the status condition to a continuously attended location.

8. The portable pump house according to claim 1:
wherein the means for detecting and reporting a status condition to an external location includes reporting means coupled to the exterior of the housing structure to alert on-site personnel.

9. A portable system for producing water pressure comprising:
a fire pump coupled to a fire pump mounting base, the fire pump including a fire pump inlet and a fire pump discharge,
a fire pump driver operably coupled to the fire pump,
means for controlling the fire pump driver operably coupled to the fire pump driver,
a pressure control pump in parallel fluid flow communication with the fire pump, the pressure control pump coupled to a pressure control pump mounting base, the pressure control pump including a pressure control pump inlet and a pressure control pump discharge,
means for controlling the pressure control pump operably coupled to the pressure control pump,
water inlet piping in fluid communication with the fire pump inlet and the pressure control pump inlet,
water discharge piping in fluid communication with the fire pump discharge and the pressure control pump discharge,
means for electrical power generation positioned within the housing structure, and
means for automatically detecting and reporting a status condition to a remote location.

10. The portable system according to claim 9:
further including means for internal temperature control.

11. The portable system according to claim 9 further including:
means for water discharge from the inside of the housing structure to the outside of the housing structure.

12. The portable system according to claim 9 further including:
a liquid-to-liquid heat exchanger on the fire pump driver.

13. The portable system according to claim 9 further including:
a main relief valve sized to flow a predetermined capacity of the fire pump.

14. The portable system according to claim 9 further including:
one or more eccentric reducers coupled to the fire pump inlet and/or the fire pump discharge.

15. The portable system according to claim 9 further including:
a mounting base structure adapted for use with prefabricated spacers to align the fire pump with inlet and discharge piping.

16. The portable system according to claim 9 further including:
office space or parts storage or sleeping quarters or any combination.

17. The portable system according to claim 9 further including:
means for freeze protection for all water lines positioned within the housing structure.

18. The portable system according to claim 17:
wherein the means for freeze protection includes means for ground fault protection.

19. A method of producing water pressure using a portable pump house, the method comprising:
transporting the portable pump house to a location in need of a temporary water pressure generation system, the portable pump house comprising,
a portable housing structure,
a fire pump positioned within the housing structure, the fire pump including a fire pump inlet and a fire pump discharge,
a fire pump driver operably coupled to the fire pump,
means for controlling the fire pump driver operably coupled to the fire pump driver,
a pressure control pump in parallel fluid flow communication with the fire pump, the pressure control pump positioned within the housing structure, the pressure control pump including a pressure control pump inlet and a pressure control pump discharge,
means for controlling the pressure control pump operably coupled to the pressure control pump,
means for electrical power generation positioned within the housing structure, and
means for automatically detecting and reporting a status condition to an external location,
coupling the portable pump house to a water supply,
coupling the portable pump house to a system adapted for receiving water pressure, and
operating the portable pump house to produce water pressure.

20. A method according to claim 19 further including:
detecting a status condition and automatically reporting the status condition to an external location.

21. A method according to claim 19 further including:
diverting a flow of water from the fire pump discharge to a liquid-to-liquid heat exchanger on the fire pump driver to cool the fire pump driver.

22. A method according to claim 20:
wherein the system adapted for receiving water pressure comprises a fire suppression sprinkler system.
